(19) United States
(12) Patent Application Publication
(10) Pub. No.: US 2013/0154499 A1
(43) Pub. Date: Jun. 20, 2013

(54) CIRCUIT ARRANGEMENT AND METHOD FOR STARTING AND OPERATING A HIGH-PRESSURE DISCHARGE LAMP

(71) Applicant: Joachim Muehlschlegel, Groebenzell (DE)

(72) Inventor: Joachim Muehlschlegel, Groebenzell (DE)

(73) Assignee: OSRAM AG, Muenchen (DE)

(21) Appl. No.: 13/810,210

(22) PCT Filed: Aug. 30, 2011
(86) PCT No.: PCT/EP2011/064855

§ 371 Date: Jan. 15, 2013

(30) Foreign Application Priority Data
Sep. 9, 2010 (DE) 10 2010 040 449.7

(51) Int. Cl. H05B 41/04

(52) U.S. Cl. CPC H05B 41/04
USPC 315/224

(57) ABSTRACT

A circuit arrangement may include: a half-bridge arrangement with a half-bridge center point, connected to an intermediate circuit voltage with a reference potential and a feed voltage potential; a lamp inductor connected at one end to the half-bridge center point; a starting stage connected to the other end of the lamp inductor and to the intermediate circuit voltage; a first switch connected between the reference potential and the starting stage; a series circuit of a first and a second capacitor connected to the intermediate circuit voltage; terminals for connecting a high-pressure discharge lamp, a first terminal being connected to the starting stage and a second terminal being connected to a node between the first and second capacitors; a two-port network, a first port of said two-port network connected to the starting stage and a second port of said two-port network connected to the node between the first and second capacitors.

### TECHNICAL FIELD

The invention relates to a circuit arrangement and to a method for starting and operating a high-pressure discharge lamp with a rectifier circuit, which outputs an intermediate circuit voltage, a half-bridge converter for generating an AC voltage, and a superposed starting unit for generating a starting voltage for the purpose of starting the high-pressure discharge lamp.

### BACKGROUND

The invention arises from a circuit arrangement and a method for starting and operating a high-pressure discharge lamp of the type referred to in the independent claims.

The invention relates in particular to operating devices for high-pressure discharge lamps that are constructed on the basis of a half-bridge circuit with coupling capacitors. Known operating devices with a half-bridge circuit are operated with AC line voltage, for example, and have a rectifier circuit that provides a frequently regulated DC voltage. This voltage is also frequently referred to as intermediate circuit voltage.

Due to the principle involved, the maximum voltage that can be applied to the high-pressure discharge lamp in the case of operating devices with a half-bridge is half the intermediate circuit voltage, that is to say at the most around 250 V, since half the voltage drops out at the coupling capacitors. This maximum voltage that can be applied to the high-pressure discharge lamp is important in particular during the starting of the high-pressure discharge lamp, also referred to as the lamp in the following, if the said lamp is ‘run up’ shortly after starting, that is to say shortly after the establishment of an electrical breakdown between the lamp electrodes. This is always a troublesome point of operation in the case of high-pressure discharge lamps since the electrodes of the gas discharge lamp burner are still cold at this point.

When operating a gas discharge lamp with alternating current, the initiation of arcing is fundamentally problematical. When operating with alternating current, a cathode becomes an anode and vice versa an anode a cathode during a commutation of the operating voltage. Due to the principle involved, the cathode-to-anode transition is not problematical since the electrode's temperature has no influence on its operation as an anode. In the case of the anode-to-cathode transition, the electrode's capacity to be able to deliver a sufficiently high current is dependent on its temperature. If the said temperature is too low, the electric arc changes over during the commutation, mostly after crossing through the zero point, from a point arc initiation mode to a diffuse arc initiation mode. This change over is accompanied by a frequently visible collapse in light emission, which can be perceived as flickering. In the worst case scenario, the lamp goes out entirely.

Sensibly, the lamp is therefore operated in point arc initiation mode since the arc initiation is very small and therefore very hot in this case. The consequence is that due to the higher temperature at the small initiation point in this case, less voltage is needed to be able to deliver sufficient current.

In the following, commutation is regarded as the operation during which the polarity of the voltage changes, and therefore during which a marked change in current or voltage occurs. In the case of an essentially symmetrical operating mode of the lamp, the voltage or current zero crossover is located in the middle of the commutation period. It should be noted in this respect that voltage commutation usually always proceeds more quickly than current commutation.

It is known from ‘The boundary layers of AC arcs at HID electrodes: phase resolved electrical measurements and optical observations’, O. Langenscheidt et al., J. Phys D 40 (2007), p. 415-431 that in the case of a cold electrode and diffuse arc initiation, the voltage initially rises after commutation since the electrode that is too cold can only deliver the current needed by means of a higher voltage. If the device for operating the gas discharge lamp can not deliver this voltage, then the aforesaid flickering occurs.

This problem emerges particularly markedly during the start-up of the lamp since the electrodes are only at ambient temperature in this case, and not yet at their operating temperature of over 2000° C. There is a high probability in this case that the lamp will go out again immediately after starting if the voltage applied to the lamp is too small. This voltage is usually referred to as transfer voltage since it instigates the transfer of the high-pressure discharge lamp from a glow discharge shortly after starting to an arc discharge. In the case of some types of high-pressure discharge lamps, the maximum 250 V transfer voltage that an operating device constructed on the basis of a half-bridge can deliver is too little to ensure certain starting of the high-pressure discharge lamp.

A further problem of half-bridge operating devices consists in the fact that due to the capacitors connected in series with the high-pressure discharge lamp, they can not apply any DC current phases to the high-pressure discharge lamp. The said DC current phases have already been part of the state of the art for some time in the case of operating devices with a full bridge since they ensure rapid and precise heating of the lamp electrodes.

For the purpose of solving the first problem, it is an approach known from the state of the art to connect a switch in parallel with one of the coupling capacitors to discharge the said capacitor and raise the transfer voltage. A circuit arrangement of this type is known from WO2002/32195. In this case, prior to starting the high-pressure discharge lamp, a switch with a resistor connected in series is connected in parallel with one of the coupling capacitors, and the said capacitor fully discharged upon the closing of the switch.

With regard to the other problem, no solution is known from the state of the art.

Known operating devices usually make use of a so-called superposed starting unit for starting the high-pressure discharge lamp, which starting unit is connected in series with the lamp and generates the starting voltage required for a breakdown in the gas discharge lamp burner. These superposed starting units usually consist of a starting transformer, the starting voltage being generated on the secondary side of the said transformer, and a so-called starting circuit, consisting of a starting capacitor and a switch, being connected on the primary side of the said transformer. The series circuit consisting of starting capacitor and switch is connected in parallel with the primary winding of the starting transformer. The secondary side of the starting transformer is connected in series with the high-pressure discharge lamp. The switch in these superposed starting units frequently includes a spark gap. However, this has the problem of high tolerance of the breakdown voltage and therefore the starting of the high-pressure discharge lamp is not always optimal. In the case of advanced starting units, therefore, the switch is implemented as an externally controlled switch, which consists of a transistor with the associated activation system. However, this variant has the problem of complex implementation and therefore makes the operating device significantly more expensive.

### OBJECT

The object of the invention is to disclose a circuit arrangement and a method for starting and operating a high-pressure discharge lamp, which no longer have the aforementioned disadvantages.

### SUMMARY

The solution to the object with reference to the circuit arrangement is effected according to the invention with the aid of a circuit arrangement for starting and operating a high-pressure discharge lamp, having a half-bridge arrangement with a half-bridge center point, said half-bridge arrangement being connected to an intermediate circuit voltage with a reference potential and a feed voltage potential, a lamp inductor, which is connected at one end to the half-bridge center point, a starting stage, which is connected to the other end of the lamp inductor and to the intermediate circuit voltage, a first switch, which is connected between the reference potential of the intermediate circuit voltage and the starting stage, a series circuit including a first and a second capacitor, said series circuit being connected to the intermediate circuit voltage, terminals for connecting a high-pressure discharge lamp, wherein a first terminal is connected to the starting stage and a second terminal is connected to the node between the first and second capacitors, a two-port network, the first port of said two-port network being connected to the starting stage and the second port of said two-port network being connected to the node between the first and second capacitors, wherein the first switch is used for generating starting pulses for starting a high-pressure discharge lamp which is connected to the circuit arrangement and for discharging the second capacitor via the two-port network. This ensures a reliable and gentle start-up of the high-pressure discharge lamp, in that the transfer voltage is raised and heating of the electrodes of the gas discharge lamp burner takes place after the start-up.

For the purpose of raising the transfer voltage, the second capacitor is preferably discharged to a predetermined voltage. In this respect, the predetermined voltage preferably lies between 10 V and 200 V, and in particular between 20 V and 150 V.

For the purpose of discharging the second capacitor, the first switch is, in this respect, preferably activated in a clocked manner for a predetermined period. It is particularly preferred for the first switch to be activated with the aid of pulse-width modulation.

The solution to the object with reference to the method is effected according to the invention with the aid of a method for starting and operating a high-pressure discharge lamp with an aforesaid circuit arrangement and the following steps:
generation of a starting voltage and discharge of the second capacitor to a predetermined first voltage by means of clocked activation of the first switch with a first frequency and a first pulse duty factor for a first time period,
charging of the second capacitor to a predetermined second voltage and generation of a starting voltage by means of clocked activation of the first switch with a second frequency and a second pulse duty factor for a second time period,
permanent opening of the first switch and generation of a square-wave AC voltage for operating the high-pressure discharge lamp.

Preferably, the length of the first time period is dependent on the detection of an electrical breakdown in the high-pressure discharge lamp. Preferably, the first time period from the detection of the electrical breakdown lasts for a further predetermined period. This ensues a DC voltage phase, which brings one of the electrodes of the gas discharge lamp burner to operating temperature as quickly as possible. The length of the DC voltage phase is in this respect 0.1 sec to 1 sec., and preferably 0.2 sec to 0.6 sec. The optimal length of the DC voltage phase is dependent in this respect on the type of lamp and the wattage of the high-pressure discharge lamp.

It is particularly preferable for the first switch, while generating the square-wave AC voltage, to be activated with the second frequency and the second pulse duty factor for a further predetermined third time period.

Further advantageous developments and embodiments of the inventive circuit arrangement and the inventive method for starting and operating a high-pressure discharge lamp arise from further dependent claims and from the following description.

### BRIEF DESCRIPTION OF THE DRAWING(S)

Further advantages, features, and details of the invention arise on the basis of the following description of exemplary embodiments and also on the basis of the drawings, in which elements that are identical or have identical functions are provided with identical reference symbols. In this respect:

FIG. 1 shows a schematic circuit diagram of the inventive circuit arrangement,

FIG. 2 shows a circuit diagram of the inventive circuit arrangement with the starting stage represented,

FIG. 3 shows a circuit diagram of the inventive circuit arrangement with the starting stage represented and the two-port network represented,

FIG. 4 shows a graph of the lamp voltage, the lamp current and the voltage at the capacitor C2 of the inventive circuit arrangement during the implementation of the inventive method,

FIG. 5 shows an enlarged extract of the signal profiles in FIG. 4,

FIG. 6 shows a further extract of the signal profiles in FIG. 4, which shows the section from the start-up to the electrical breakdown of the gas discharge lamp burner,

FIG. 7 shows a further extract of the signal profiles in FIG. 4, which shows the start-up of the inventive circuit arrangement and of the high-pressure discharge lamp,

FIG. 8 shows a slightly different extract of the starting operation,

FIG. 9 shows the transition from DC operation to AC operation,

FIG. 10 shows the situation in FIG. 9 with a larger time base of 50 ms/div.

### PREFERRED EMBODIMENT OF THE INVENTION

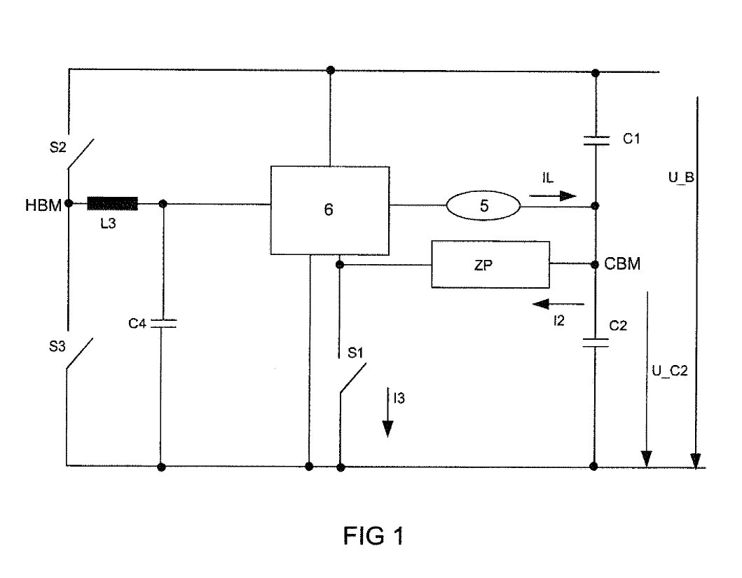

FIG. 1 shows a schematic circuit diagram of the inventive circuit arrangement. In terms of its basic principle, the inventive circuit arrangement includes an operating device for gas discharge lamps with a half-bridge with power-supply switches S2 and S3, and symmetrical center voltage through the two coupling capacitors C1 and C2. The half-bridge is connected to an intermediate circuit voltage U_B, which usually is approx. 400 V in the case of operating devices with 220 V AC voltage. The intermediate circuit voltage is applied between a feed voltage potential and a reference potential. Due to the modular technology of the semiconductors, the intermediate circuit voltage B_B is limited to a maximum of 500 V. In the case of higher voltages, semiconductors with different technology would have to be employed, which would be markedly more expensive and would make the operating device uneconomic. A high-pressure discharge lamp 5, a starting unit 6, and an inductor L3 are connected in series between the center point HBM of the half-bridge and the center point CBM of the two capacitors. A two-port network ZP is connected between the center point CBM of the two capacitors and the starting unit 6. A first switch S1 is connected between the starting unit 6 and the reference potential. This switch performs two functions in the inventive circuit arrangement. In its first function, the switch is used as a starting switch for the primary circuit of the starting unit 6. In its second function, the switch is used as a switch for discharging the coupling capacitor C2.

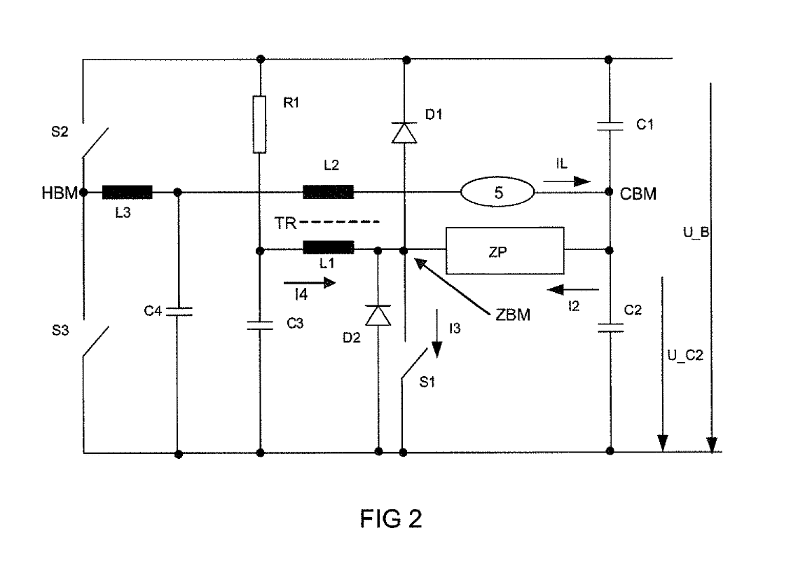

FIG. 2 shows the inventive circuit arrangement with details of the starting unit 6. The starting unit 6 has a starting transformer TR with a primary winding L1 and a secondary winding L2. The secondary winding L2 is connected in series with the high-pressure discharge lamp 5 and the inductor L3. One terminal of the primary winding L1 is connected to a charging resistor R1 and to a starting capacitor C3. The charging resistor is in turn connected to the feed voltage potential and the starting capacitor to the reference potential. The other terminal of the primary winding is connected to the node ZBM between two diodes D1 and D2, which are arranged in series and are connected to the intermediate circuit voltage. The first switch S1 and also the two-port network ZP are likewise connected to this node ZBM. As can be seen from the circuit diagram, the starting capacitor C3 can be discharged and a high current generated in the primary circuit with the aid of the switch S1. Due to this high primary current, a starting voltage is generated at the secondary winding L2 and fed to the high-pressure discharge lamp 5.

Via the two-port network ZP, the first switch S1 is also connected in parallel with the coupling capacitor C2.

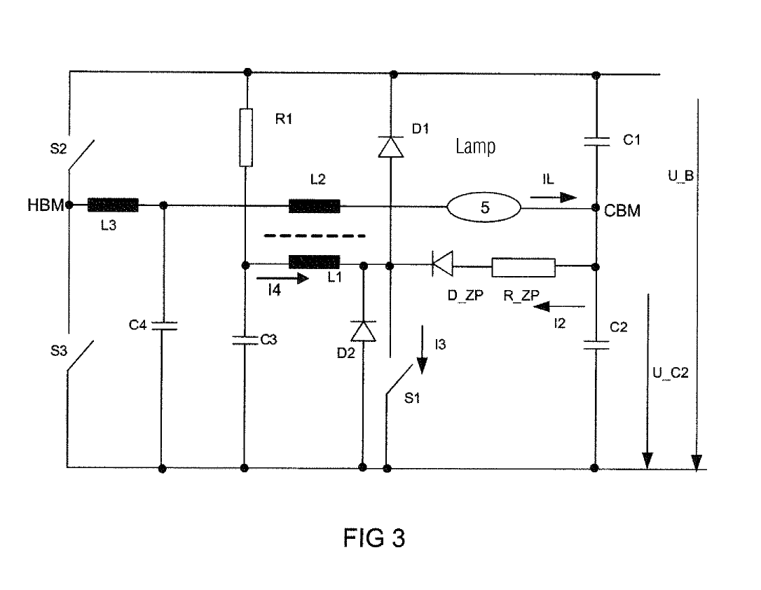

FIG. 3 then shows the inventive circuit arrangement with an exemplary embodiment of the two-port network ZP, which in this case consists of a series circuit containing a diode D_ZP and a resistor R_ZP. In this respect, the diode's cathode is connected to the first switch S1. If the first switch S1 is closed, then a current I3 flows through the first switch S1, which current is made up of a current I2 from the coupling capacitor C2 and a current I4 from the starting capacitor C3. In this respect, the two-port network ZP limits the discharging current I2 from the coupling capacitor C2. In this respect, the resistor R_ZP of the two-port network limits the current while the first switch S1 is closed, and the diode D_ZP of the two-port network defines the current direction, so that the capacitor C2 can only be discharged through the two-port network, and while the first switch is open no current can flow into the coupling capacitor. The resistor R_ZP is dimensioned such that the peak value of the current I2 through the two-port network as a proportion of the peak value of the total current I3 is less than 40%. It is particularly preferred for the peak value of the current I2 through the two-port network as a proportion of the peak value of the total current I3 to be less than 20%. In this respect, the resistor R_ZP must be dimensioned such that it can absorb the power for the period during which a current is flowing through it. The work to be absorbed therefore is I2*U_C2 DC*(t₄−t₂). In the present embodiment, the two-port network has been dimensioned as follows:

R_ZP: 27 R, 2 W

D_ZP: 600 V, 1 A

According to the invention, therefore, the switch can be used simultaneously as a starting switch and for discharging the coupling capacitor C2. Only one switch and the associated activation system is necessary, therefore, which saves costs and space. During the inventive method, which can be implemented with this circuit arrangement, the first switch S1 is then activated with various frequencies and pulse duty factors for several consecutive time periods.

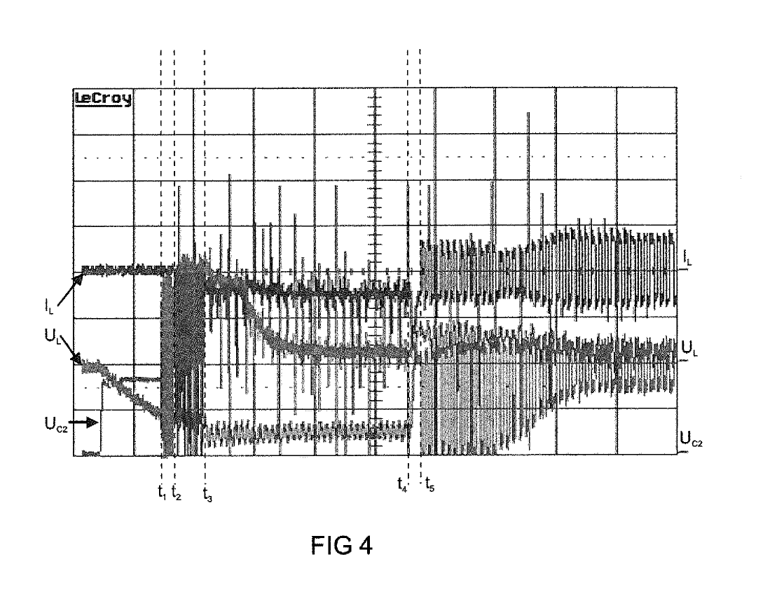

FIG. 4 shows a number of relevant variables that clarify the full start-up method. The time resolution, 100 ms/div., is selected such in this case that the complete start-up operation can be shown. At the time point t₁, the voltage at the coupling capacitor C2 is half the intermediate circuit voltage, about 210 V. As from the time point t2, starting pulses are generated, which is reflected on the one hand in the lamp voltage signal, in the lamp current signal, and in the voltage U_C2 at the coupling capacitor C2, which drops from approx. 210 V to between 50 V and 60 V, to raise the transfer voltage from 210 V to 420 V−50 V=370 V. During this period, the first switch is activated with a first frequency of about 3 kHz and a first pulse duty factor at an ON duration of 50 us to 100 us. At the time point t₃, the high-pressure discharge lamp 5 starts and the DC voltage phase begins, which lasts until the time point t₅, and during which an electrode of the gas discharge lamp burner is heated up. In one embodiment, the time point t₅ is dependent on the time point of start-up of the high-pressure discharge lamp 5, to achieve a defined length of the DC voltage phase. In this respect, the DC voltage phase is between 0.1 sec and 1 sec, and preferably between 0.2 sec and 0.6 sec, long. During the phase between the time point t₄ and the time point t₅, the first switch is activated with a second frequency of 50 Hz to 5 kHz and a second pulse duty factor at an ON duration of 4 us, to charge up the coupling capacitor C2 to a voltage U_C2_KM of approx. 280 V for the first commutation. Depending on the embodiment, the voltage may lie between 250 V and 500 V. At the time point t₅, change over to AC operation occurs, and following a build-up phase during which the second electrode of the gas discharge lamp burner is also heated up, the lamp finds itself in stable operation. The change-over to alternating current is effected in two stages: during the first stage, which begins at the time point t₄, the first switch is activated with a second pulse duty factor and a second frequency of 50 Hz to 5 kHz, the ON duration of the first switch being markedly shorter compared with the first pulse duty factor, in this exemplary embodiment 4 us. The consequence is that the coupling capacitor C2 is slowly charged up again and the voltage U_C2 rises accordingly. At the time point t₅, the voltage U_C2 at the coupling capacitor C2 has reached a maximum so that the transfer voltage at the first commutation is correspondingly high again, and change-over to AC operation occurs as already explained above. During AC operation, the first switch S1 is activated with the second pulse duty factor and the ON duration of 4 us, and the second frequency of 50 Hz to 5 kHz, for a further time period to continue to generate starting pulses. This ensures that in the case of an unforeseen extinction of the high-pressure discharge lamp after a commutation, the said lamp is immediately started again. Since the second electrode is still quite cold at the start of AC operation, an extinction of the discharge arc after the commutation can not always be prevented.

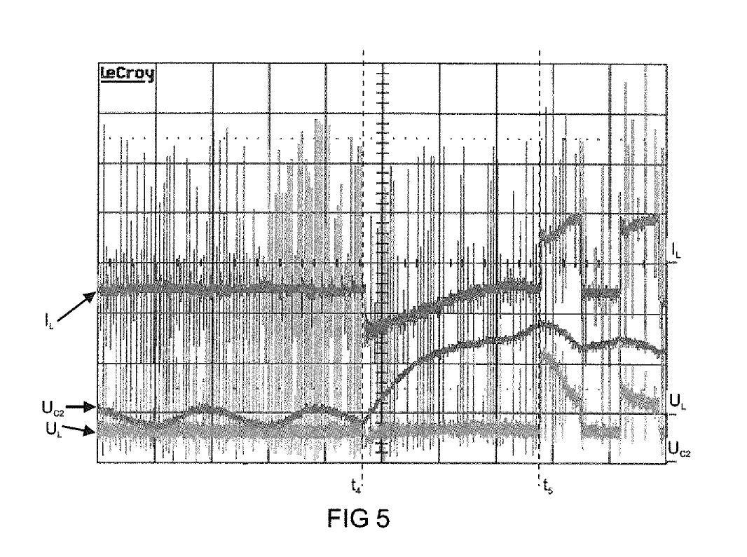

FIG. 5 shows an enlarged extract of the signal profiles in FIG. 4. The time base is set to 5 ms/div. in this case. Up to the time point t4, the voltage U_{C2} at the coupling capacitor C2 is low since the pulse duty factor is set such that the ON duration of the first switch S1 is very high. At the time point t₄, the pulse duty factor is changed over and the ON duration is then significantly lower than previously. The consequence is that the coupling capacitor C2 is discharged substantially less strongly, and the voltage U_C2 at the said capacitor therefore rises again. As a consequence of the reversal, the voltage U_C2 at the coupling capacitor C2 rises to a voltage U_C2_KM, which is higher than the intermediate circuit voltage U B. At the time point t₅, the voltage at the coupling capacitor C2 is highest, and the half-bridge is put into operation. Following the change-over of the half-bridge, a higher transfer voltage than the intermediate circuit voltage is therefore available to the high-pressure discharge lamp 5. As from this time point, the lamp is operated with alternating current.

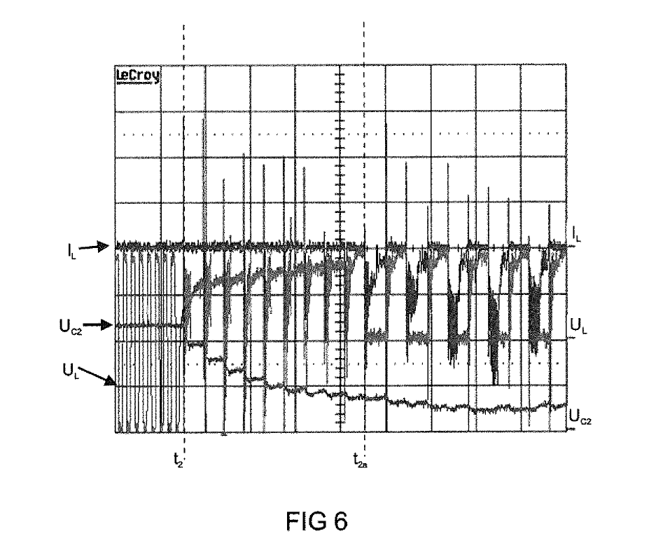

FIG. 6 shows a further extract of the signal profiles in FIG. 4. The section from start-up to the electrical breakdown of the gas discharge lamp burner is visible in this case. The time base is 1 ms/div. in this case. Prior to the time point t₂, no starting pulses are being generated yet; in this case, the half-bridge is running in open-circuit operation with a predetermined frequency, which can be seen from the square-wave lamp voltage UL. At the time point t2, the first switch S1 is operated with the first frequency and the first pulse duty factor. The ON duration of the first switch is quite high, and consequently the coupling capacitor C2 discharges itself visibly at each switch-on. The switching-on of the first switch causes starting pulses to be generated, which are applied to the gas discharge lamp burner. At the time point t₂ₐ, the gas discharge lamp burner begins to achieve breakdown, which can be seen from the pulse-shaped current profile. At the time point of the first electrical breakdown in the gas discharge lamp burner, the voltage U_C2 at the coupling capacitor C2 is already significantly lowered, and the transfer voltage for the high-pressure discharge lamp 5, or the gas discharge lamp burner of the high-pressure discharge lamp 5 respectively, is correspondingly raised.

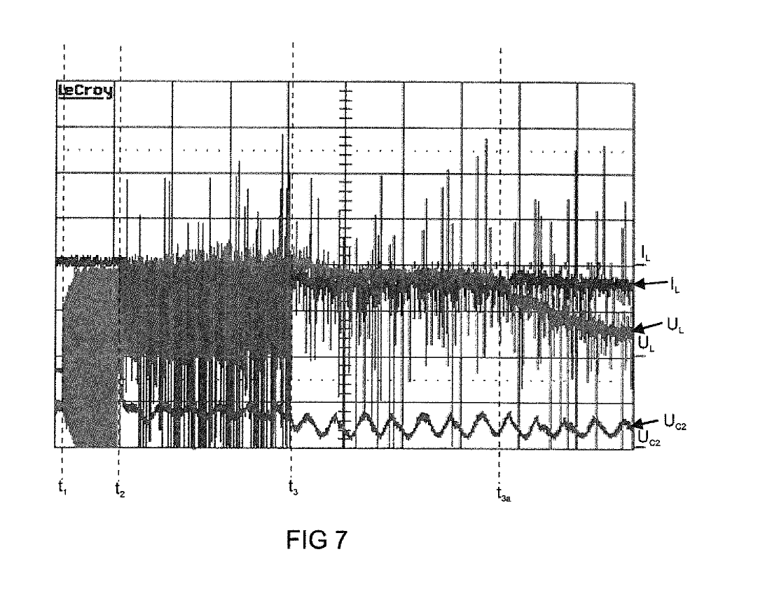

FIG. 7 shows a further extract of the signal profiles in FIG. 4. The start-up of the inventive circuit arrangement and of the high-pressure discharge lamp 5 is shown. The time points again correspond to the time points in FIG. 4. The time base in this figure is 20 ms/div. At the start, at the time point t₁, the half-bridge is operated with a predetermined frequency as already mentioned above, which can be seen from the square-wave lamp voltage UL. At this time point, the upstream power factor correction circuit also begins its work and raises the intermediate circuit voltage, which is likewise reflected in the voltage U_C2 at the coupling capacitor C2. As from the time point t₂, starting pulses are generated. This can be clearly seen from the very uneven current profile of the lamp current IL. As from the time point t₃, a glow discharge becomes established in the gas discharge lamp burner, which is slowly converted into an arc discharge as from the time point t₃ₐ. This is shown by a slow fall in the lamp voltage UL. The lamp current IL rises slightly and displays a considerably more stable profile.

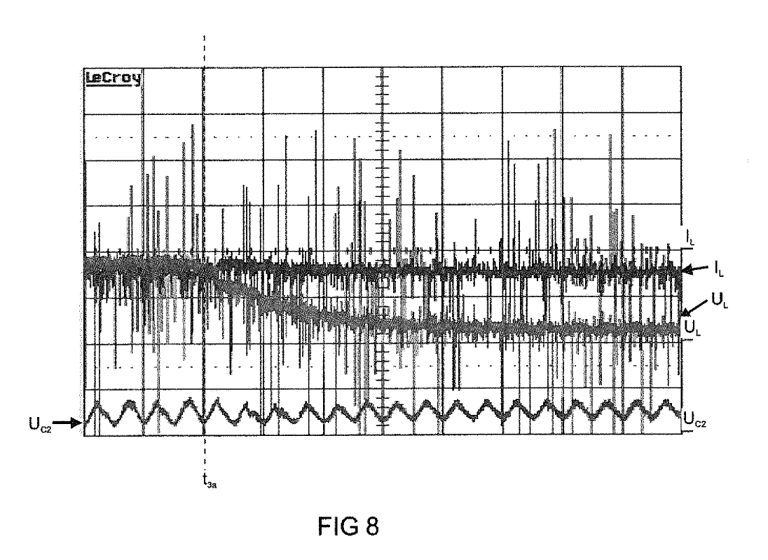

FIG. 8 shows a slightly different extract of the starting operation, likewise with a time resolution of 20 ms/div. The conversion of the glow discharge into an arc discharge is shown in this case. At the time point t₃ₐ, the glow discharge is slowly converted into an arc discharge, which gradually stabilizes. After a certain time, the lamp voltage UL stops falling and the arc has therefore become established to the extent that it is possible to start converting the gas discharge lamp burner into the stable burning condition at nominal power. This is effected by means of further operation with direct current, during which an electrode of the gas discharge lamp burner is heated up.

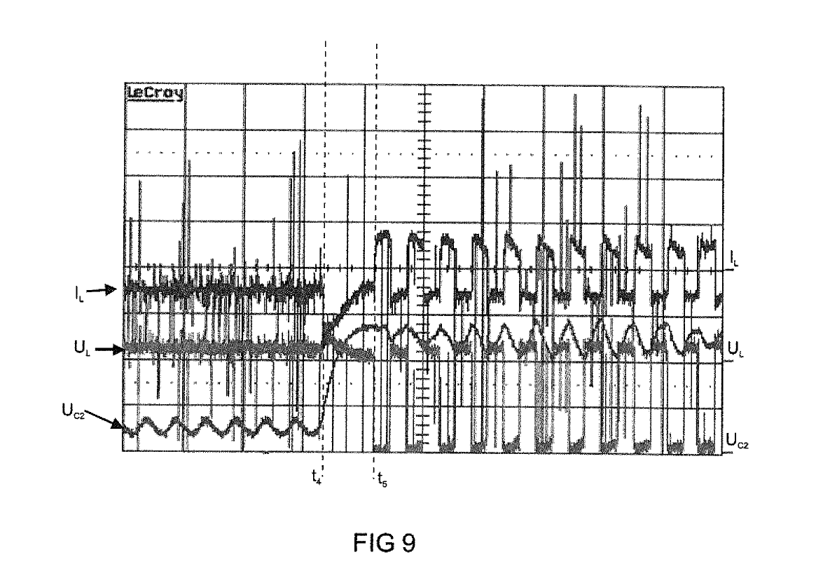

FIG. 9 shows the transition from DC operation to AC operation. The time base is 20 ms/div. in this case, as previously. Up to the time point t₄, the high-pressure discharge lamp is in DC operation; at this time point, the activation of the first switch S1 changes over and the said switch is then operated with a markedly reduced ON duration. As a result, the coupling capacitor C2 is charged up again and its voltage U_C2 rises to half the intermediate circuit voltage. Once this has happened, the first commutation is instigated at the time point t₅, in that the half-bridge changes over and the lamp voltage and the direction of the lamp current are therefore inverted. In this operating mode, the second electrode is then also heated up.

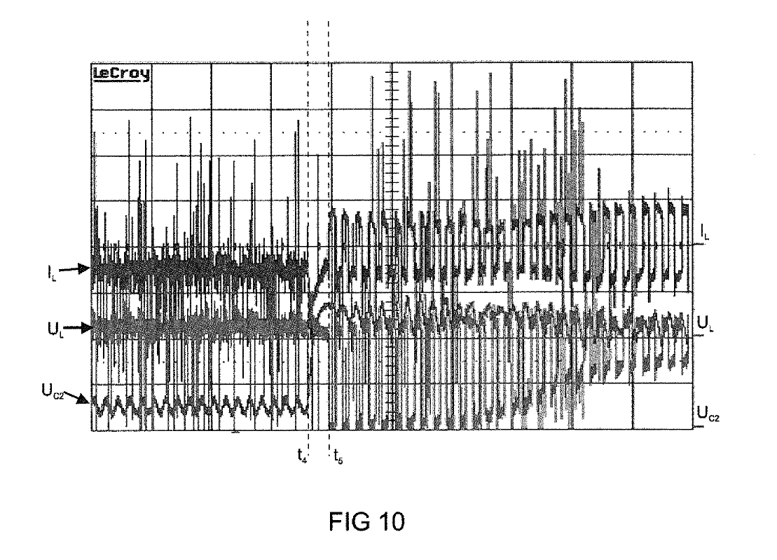

FIG. 10 shows the situation with a larger time base of 50 ms/div. It can be clearly seen that the second electrode is still too cold in this case, so that a further glow discharge takes place in this case, which can be seen from the raised lamp voltage in this current direction. The lamp runs asymmetrically for a while until the second electrode has been heated up to the extent that the glow discharge in this current direction likewise leads to an arc discharge, and the lamp voltage falls accordingly.

1. A circuit arrangement for starting and operating a high-pressure discharge lamp, comprising:
a half-bridge arrangement with a half-bridge center point, said half-bridge arrangement being connected to an intermediate circuit voltage with a reference potential and a feed voltage potential,
a lamp inductor, which is connected at one end to the half-bridge center point,
a starting stage, which is connected to the other end of the lamp inductor and to the intermediate circuit voltage,
a first switch, which is connected between the reference potential of the intermediate circuit voltage and the starting stage,
a series circuit of a first and a second capacitor, said series circuit being connected to the intermediate circuit voltage,
terminals for connecting a high-pressure discharge lamp, wherein a first terminal is connected to the starting stage and a second terminal is connected to a node between the first and second capacitors,
a two-port network, a first port of said two-port network being connected to the starting stage and a second port of said two-port network being connected to the node between the first and second capacitors, wherein
the first switch can be activated in order to generate starting pulses for starting a high-pressure discharge lamp which is connected to the circuit arrangement and in order to discharge the second capacitor via the two-port network.

2. The circuit arrangement as claimed in claim 1, wherein the two-port network is a series circuit of a resistor and a diode.

3. The circuit arrangement as claimed in claim 2, wherein the resistor is dimensioned such that a peak value of a current through the two-port network is at most 40% of a peak value of a current through the first switch.

4. The circuit arrangement as claimed in claim 1, wherein the circuit arrangement is configured to discharge the second capacitor to a predetermined voltage.

5. The circuit arrangement as claimed in claim 4, wherein the predetermined voltage lies between 10 V and 200 V.

6. The circuit arrangement as claimed in claim 1, wherein the circuit arrangement is configured to activate the first switch in a clocked manner for a predetermined period for the purpose of discharging the second capacitor.

7. The circuit arrangement as claimed in claim 6, wherein the circuit arrangement is configured to activate the first switch with the aid of pulse-width modulation.

8. A method for starting and operating a high-pressure discharge lamp with a circuit arrangement, the circuit arrangement comprising:
a half-bridge arrangement with a half-bridge center point, said half-bridge arrangement being connected to an intermediate circuit voltage with a reference potential and a feed voltage potential,
a lamp inductor, which is connected at one end to the half-bridge center point, a starting stage, which is connected to the other end of the lamp inductor and to the intermediate circuit voltage,
a first switch, which is connected between the reference potential of the intermediate circuit voltage and the starting stage,
a series circuit of a first and a second capacitor, said series circuit being connected to the intermediate circuit voltage,
terminals for connecting a high-pressure discharge lamp, wherein a first terminal is connected to the starting stage and a second terminal is connected to a node between the first and second capacitors,
a two-port network, a first port of said two-port network being connected to the starting stage and a second port of said two-port network being connected to the node between the first and second capacitors, wherein
the first switch can be activated in order to generate starting pulses for starting a high-pressure discharge lamp which is connected to the circuit arrangement and in order to discharge the second capacitor via the two-port network,
the method comprising:
generating a starting voltage,
discharging the second capacitor to a predetermined first voltage by means of clocked activation of the first switch with a first frequency and a first pulse duty factor for a first time period,
generating a starting voltage,
charging of the second capacitor to a predetermined second voltage by means of clocked activation of the first switch with a second frequency and a second pulse duty factor for a second time period,
generating a square-wave AC voltage for operating the high-pressure discharge lamp, and
opening the first switch permanently.

9. The method as claimed in claim 8, wherein an electrical breakdown is detected in the lamp and a length of the first time period is dependent on the detection of the electrical breakdown.

10. The method as claimed in claim 9, wherein the first time period from the detection of the electrical breakdown lasts for a further predetermined period.

11. The method as claimed in claim 10, wherein the predetermined period from the detection of the electrical breakdown is 0.1 sec to 1 sec.

12. The method as claimed in claim 11, wherein the predetermined period from the detection of the electrical breakdown is 0.2 sec to 0.6 sec.

13. The method as claimed in claim 8, wherein the first switch, while generating the square-wave AC voltage, is activated with the second frequency and the second pulse duty factor for a further predetermined third time period.

14. The method as claimed in claim 13, wherein the third time period is 0.1 sec to 1 sec long.

15. The method as claimed in claim 14, wherein the third time period is 0.2 sec to 0.6 sec long.

16. The circuit arrangement as claimed in claim 5, wherein the predetermined voltage lies between 20 V and 150 V.
